(19) United States
(12) Patent Application Publication
(10) Pub. No.: US 2023/0023835 A1
(43) Pub. Date: Jan. 26, 2023

(54) ZONE-BASED INDICATION OF PRESENCE OF TRUSTED OR UNTRUSTED PERSONNEL

(71) Applicant: JOHNSON CONTROLS TYCO IP HOLDINGS, LLP, Milwaukee, WI (US)

(72) Inventors: Jason OUELLETTE, Westford, MA (US); Richard FOCKE, Andover, MA (US); John CASSISE, Oceanside, CA (US)

(21) Appl. No.: 17/381,032

(22) Filed: Jul. 20, 2021

(51) Int. Cl. G06Q 10/10; H04L 29/06

(52) U.S. Cl. CPC G06Q 10/1095; H04L 63/08

(57) ABSTRACT

Disclosed herein are apparatuses and methods for verifying a level of trust in a zone having multiple persons. One or more persons of the multiple persons within the zone can be identified and, based on identifying the one or more persons, it can be determined whether the one or more persons are associated with a level of trust. An observable indicator can be set to specify whether the multiple persons in the zone, including the one or more persons, are associated with the level of trust.

### TECHNICAL FIELD

The described aspects relate to autonomous personnel verification.

### BACKGROUND

Aspects of the present disclosure relate generally to autonomous personnel verification, and more particularly, to identifying and verifying personnel within a zone.

Corporations often have building-based security systems that can verify an identity of a person via one or more biometric properties. Based on identification of the person, the security system can allow or deny the person access to the building or a physical zone or area of the building. In addition, corporations often use productivity software applications to manage and host virtual meetings including employee personnel, where access to the virtual meetings can be similarly managed based on identifying a person joining the virtual meeting through the person's username and password credentials.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a computer-implemented method for verifying a level of trust in a zone having multiple persons. The method includes identifying one or more persons of the multiple persons within the zone, determining, based on identifying the one or more persons, whether the one or more persons are associated with a level of trust, and setting an observable indicator to specify whether the multiple persons in the zone, including the one or more persons, are associated with the level of trust.

Another example implementation includes an apparatus for verifying a level of trust in a zone having multiple persons including a memory, and a processor communicatively coupled with the memory and configured to execute a trust verification system for identifying one or more persons of the multiple persons within the zone, determining, based on identifying the one or more persons, whether the one or more persons are associated with a level of trust, and setting an observable indicator to specify whether the multiple persons in the zone, including the one or more persons, are associated with the level of trust.

Another example implementation includes a computer-readable medium storing instructions, executable by a processor, for verifying a level of trust in a zone having multiple persons. The instructions include instructions for identifying one or more persons of the multiple persons within the zone, determining, based on identifying the one or more persons, whether the one or more persons are associated with a level of trust, and setting an observable indicator to specify whether the multiple persons in the zone, including the one or more persons, are associated with the level of trust.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram of an example of a building floor that may have one or more zones with which a level of trust can be associated for identifying presence of trusted or untrusted personnel, in accordance with exemplary aspects of the present disclosure.

FIG. 2 is a block diagram of an example of a computing device for executing a trust verification system that can verify whether one or more persons present in a physical or virtual zone have a certain level of trust, in accordance with exemplary aspects of the present disclosure.

FIG. 3 is a flowchart of an example of a method for indicating whether persons in a zone are of a level of trust associated with the zone, in accordance with exemplary aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Aspects described herein relate to indication of trusted or untrusted personnel within a zone. In an aspect, one or more persons entering a zone can be identified, where the zone can have an associated level of trust, and a determination can be made as to whether the one or more persons comply with the associated level of trust. If so, or if all persons in the zone comply with the associated level of trust, an observable indicator can be set to indicate that the persons in the zone are trusted, or if not, the observable indicator can be set to indicate that at least one person is untrusted. Thus, by observing the observable indicator, one or more persons in the zone can easily discern whether the persons in the zone are trusted or not. For example, where at least one person in the zone is untrusted, another person may not wish to disclose certain information.

For example, determining whether the one or more persons comply with the associated level of trust can include determining whether the one or more persons have a valid digital certificate that corresponds to the level of trust. For example, the level of trust can correspond to whether or not persons in the zone have signed a non-disclosure agreement, whether or not persons in the zone have completed a training course, whether or not persons in the zone hold or hold at least a certain position within an organization, etc. In an example, the level of trust can be set for the zone for a period of time. In addition, for example, the zone can be a physical space, such as a meeting room, office, etc. within a building. In another example, the zone can be a virtual space such as a virtual meeting conducted via a productivity application (e.g., a client application associated with a productivity system). Moreover, for example, the observable indicator can be equipment within a physical zone, such as a light emitting diode (LED) bar or other visual indicator, an audio indicator, etc., or can be an indicator sent to personal devices of persons in the zone, such as an email, text message, or pup-up alert on a phone or wearable device. For example, the pop-up alert can be caused by a productivity application executing on the device and can display a pop-up window over other windows that may be displayed on the personal device. In another example, the observable indicator can be an icon on the productivity application for a virtual meeting.

In a specific example, a system can use public key infrastructure (PKI) certificate management for high assurance to determine authorized and trusted personnel from unknown, unauthorized and untrusted personnel. With this built up intelligence and leveraging information from a physical access control systems and video systems independently or unified and through mobile or wearable wireless communications in premises, cloud or hybrid deployments, the system can track the location of personnel with the ability to notify people in areas of the presence of untrusted personnel. The notification can be provided through mass notification mechanism that can include web browsers, mobile applications, software integration or through building management solutions via lighting, message boards, paging or other communications.

In this regard, for example, aspects described herein provide for protecting identities by using a general notification of trust level in the zone that is not person-specific. In addition, aspects described herein provide for informing and ensuring all personnel are aware of the presence of untrusted members, so personnel may avoid the sharing, displaying, talking, or exposing of sensitive information such as contracts, customer information, intellectual property, etc. Thus, personnel can easily verify the trust level of the zone before disclosing information and/or can be notified when the trust level changes to avoid disclosing sensitive information to non-vetted personnel.

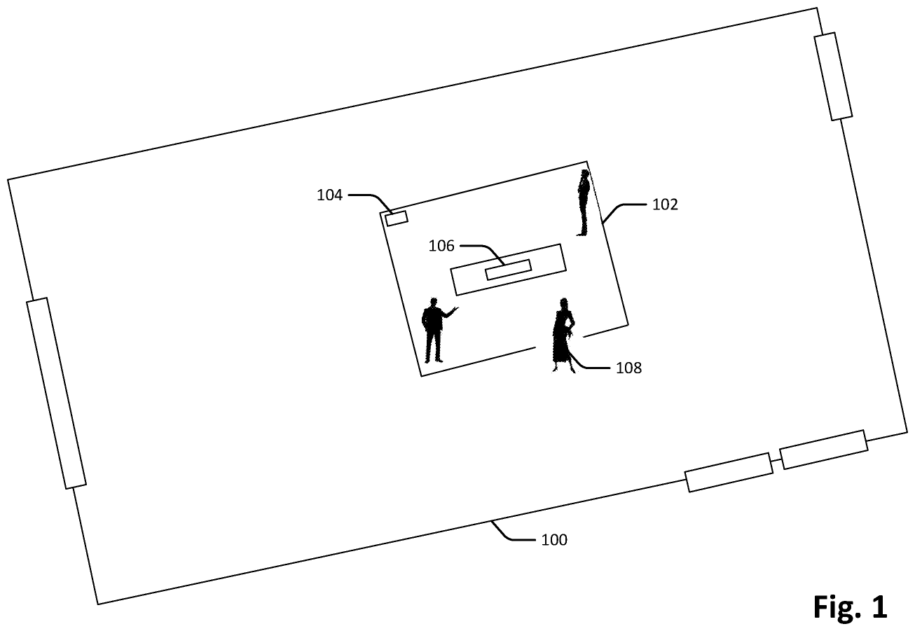

FIG. 1 is a diagram of an example of a building floor 100 that may have one or more zones with which a level of trust can be associated for identifying presence of trusted or untrusted personnel. The building floor 100 may include a zone 102, which may be a conference room, office, or other zone or area on the building floor 100. In a specific example, the zone 102 can include a biometric reader 104 that can identify one or more persons in the room based on biometric features of the one or more persons, such as facial recognition. The zone 102 may also include a zone indicator 106, which may be physical equipment, such as a LED bar or other visual device, an audio device, etc. for alerting or notifying of status of the zone 102. As described, the status of the zone 102 can relate to whether one or more trusted or untrusted persons are detected in the zone 102 based on a level of trust associated with the zone 102.

In an example, the biometric reader 104 can identify each person in the zone 102, as they enter the zone 102, periodically as they remain in the zone 102, etc., and can provide identification information to a trust verification system. The trust verification system can determine whether the identification information is associated with a level of trust assigned to the zone 102 (e.g., assigned to the zone 102 during a specific time period or otherwise). Depending on the outcome of whether each person in the zone 102 is associated with the level of trust, the trust verification system can cause the zone indicator 106 to notify whether all persons in the zone 102 are associated with the level of trust or not. For example, the zone indicator 106 can be a LED bar that displays a green color when all persons in the zone 102 are associated with the level of trust or a red color when at least one person in the zone 102 is not associated with the level of trust (or different colors for different levels of trust, etc.). In another example, zone indicator 106 can be an audio device that plays an audio alert when all persons in the zone 102 are associated with the level of trust or when at least one person in the zone 102 is not associated with the level of trust, etc.

In a specific example, the zone indicator 106 may indicate that all persons in the zone 102 are associated with the level of trust, and then may identify person 108. The trust verification system can determine that the person 108 is not associated with the level of trust. For example, this can include the trust verification system determining that the person 108 has not signed a NDA, has not passed a certain training course or certification, is not at or at least a certain position at a corporation, etc. In one example, the trust verification system can make this determination based on a PKI certificate associated (or not associated) with the person 108. Based on determining that the person 108 is not at the level of trust for the zone 102, the trust verification system can cause the zone indicator 106 to modify its indication to indicate that at least one person in the zone 102 is not associated with the level of trust. This can provide an easily observed indication so persons in the zone 102 can determine information that should or should not be divulged, while also not explicitly identifying the untrusted person. As described above and further herein, other zone indicators can be used, which may include personal devices instead of, or in addition to, indicators physically located in the zone 102. In addition, as described above and further herein, similar concepts can be applied to virtual zones, such as virtual meetings for the corporation, where presence of a person determined to be untrusted may cause display of an observable indicator to all persons, or at least one or more other persons, in the virtual meeting.

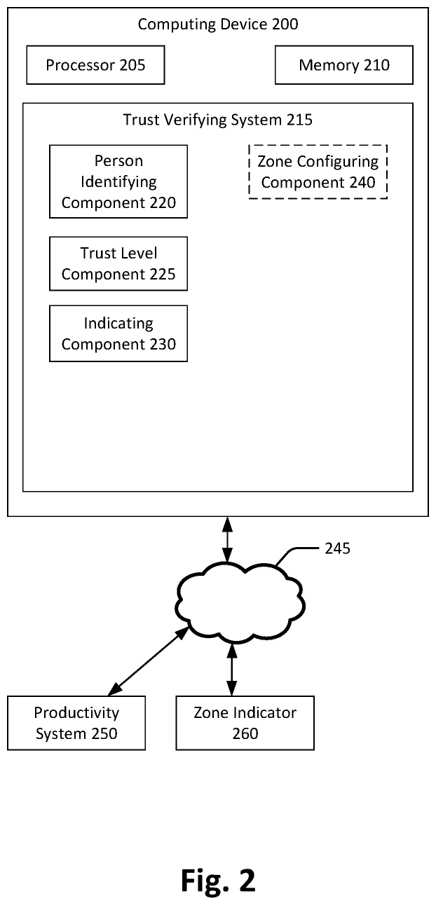

FIG. 2 is a block diagram of an example of a computing device 200 for executing a trust verification system 215 that can verify whether one or more persons present in a physical or virtual zone have a certain level of trust. Computing device 200 can include a processor 205 (and/or multiple processors) and/or a memory 210 configured to execute or store instructions or other parameters related to performing one or more processes, executing the trust verification system 215, etc. For example, processor 205 and memory 210 may be separate components communicatively coupled by a bus (e.g., on a motherboard or other portion of a computing device, on an integrated circuit, such as a system on a chip (SoC), etc.), components integrated within one another (e.g., processor 205 can include the memory 210 as an on-board component), and/or the like. Memory 210 may store instructions, parameters, data structures, etc. for use/execution by processor 205 to perform functions described herein.

In an example, the trust verification system 215 can include one or more of a person identifying component 220 for identifying one or more persons present within, or entering/exiting, a zone, a trust level component 225 for identifying a level of trust associated with the zone and/or for determining whether one or more persons identified in the zone are of the level of trust, or an indicating component 230 for setting an observable indicator to indicate whether one or more persons identified in the zone are of the level of trust or not. For example, indicating component 230 can indicate a binary indication as to whether all persons identified in the zone are of the level of trust or whether at least one person is not of the level of trust. In an example, trust verification system 215 may optionally include a zone configuring component 240 for setting or determining one or more parameters regarding the zone, which may include the level of trust associated with the zone, a type of indicator (or a configuration for the indicator) for indicating whether one or more persons in the zone are of the associated level of trust or not (or of certain different levels of trust based on different indicators), etc.

For example, computing device 200 can communicate with one or more other devices or systems via a network 245. For example, computing device 200 can communicate with a productivity system 250 for determining a zone, for determining or assisting in generating a configuration for the zone. In one example, productivity system 250 can include the zone configuring component 240, or one or more functions thereof. Thus, in one example, the productivity system 250 can be used to define the zone and the level of trust. The zone, as described, may correspond to a physical area of a building of a corporation, such as a conference room or office, a virtual area associated with the corporation, such as a virtual meeting room provided by the productivity system 250 where participants can attend, and be grouped in, a virtual meeting via a computer, tablet, phone, or other device. For example, the zone can be associated with a period of time, such as a schedule for a conference room, a schedule for a virtual meeting, etc. The productivity system 250, for example, can allow for defining the zone and the level of trust, and the level of trust can be different for the zone in different periods of time. For example, the productivity system 250 can allow for scheduling physical or virtual meetings for the corporation in different periods of time, and associating a level of trust with each meeting. In other examples, however, the level of trust may be associated with the zone regardless of period of time.

In another example, computing device 200 can communicate with a zone indicator 260 to indicate whether one or more persons in a zone are or are not associated with the level of trust for the zone. For example, the zone indicator 260 can be the indicator itself or a system that manages and communicates with the indicators. As described, the zone indicator 260 can include a visual indicator, such as a LED bar, an audio indicator, such as an audio device that can play audio alerts, a notification system that can send email, text message, or similar alerts to personal devices of the persons in the meeting, etc. In addition, in an example, the zone indicator 260 can be capable of a binary indication of whether one or more persons (or all persons) are of an associated level of trust. In another example, the zone indicator 260 can be capable of additional indications of whether one or more persons (or all persons) are associated with other levels of trust. For example, the zone indicator 260 may indicate (e.g., via different colors, different audio alerts, different text in a personal device alert, etc.) whether all persons are of at least a first level of trust or at least a second level of trust, etc.

Moreover, in an example, zone configuring component 240 or productivity system 250 can allow for configuration of the zone indicator to specify the observable indication of the level of trust(s) associated with one or more (or all) persons in the zone. For example, where zone indicator 260 is a LED or other color indicator, zone configuring component 240 or productivity system 250 can configure the zone indicator 260 with which color to display to indicate for the binary indicator that all persons are associated with the level of trust or that at least one person is not associated with the level of trust, etc. In another example, where the zone indicator 260 is associated with a physical zone in a building, the zone indicator 260 can be inside of, and/or outside of, the physical zone. Moreover, for example, where the zone indicator 260 includes a notification system, the zone indicator 260 can send indications to physical devices of persons that are scheduled to be in the meeting once they enter the physical zone or beforehand. In addition, for example, zone indicator 260 can set the observable indicator based on a timing of the person not having the level of trust entering the zone, at a random time to further protect anonymity of the person, or otherwise.

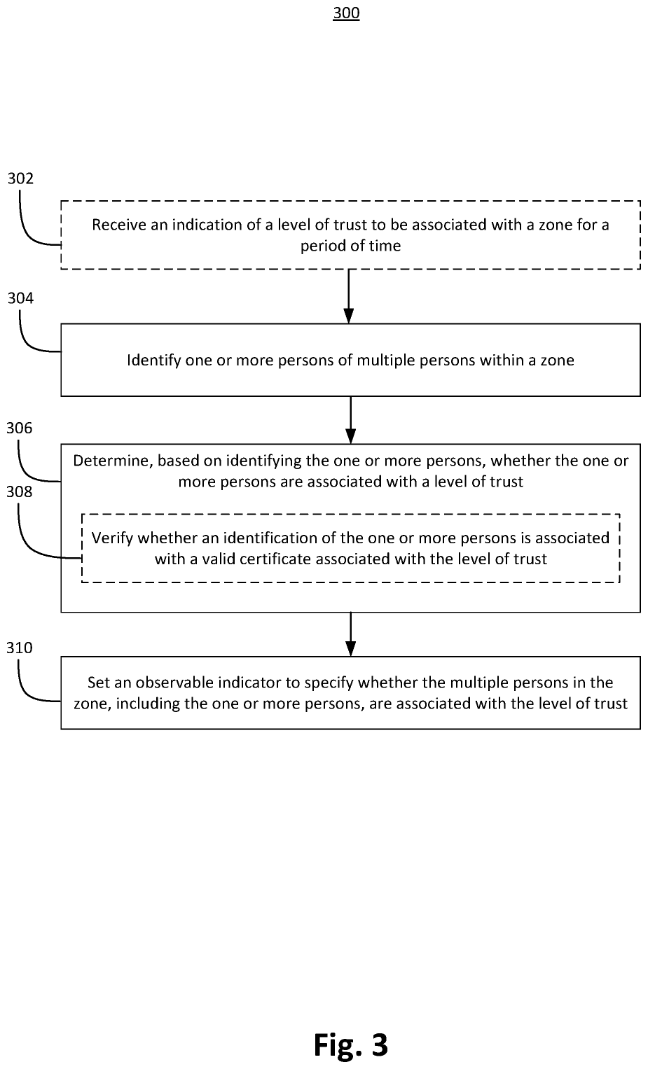

FIG. 3 is a flowchart of an example of a method 300 for indicating whether persons in a zone are of a level of trust associated with the zone. For example, method 300 can be performed by a computing device 200 and/or one or more systems or components thereof to facilitate indicating whether persons in the zone are of a certain associated level of trust or not.

At block 302, method 300 can optionally include receiving a level of trust to be associated with a zone for a period of time. In an aspect, zone configuring component 240, e.g., in conjunction with computing device 200, processor 205, memory 210, trust verification system 215, etc., can receive the indication of the level of trust to be associated with the zone for the period of time. For example, zone configuring component 240 can allow for specifying the zone (e.g., the physical or virtual zone), the level of trust to be associated with the zone, the zone indicator or configuration parameters thereof, etc. In one example, as described, zone configuring component 240 can receive at least a portion of this information from a productivity system, such as a list of physical or virtual zones for the corporation, a scheduling of meetings for the zones, and/or the like. In addition, in an example, either the zone configuring component 240 can allow for specifying the level of trust within the trust verification system 215, or can receive the level of trust from the productivity system 250. In the latter example, for instance, zone configuring component 240 can provide the productivity system 250 with the available levels of trust in the trust verification system 215 for associating with the zones, meetings in the zones, etc.

As described, for example, the levels of trust can be associated with PKI certificates, which can be associated with identities of persons in a corporation. For example, this can include PKI certificate management for High Assurance to determine authorized and trusted personnel from unknown. In an example, the trust verification system 215 can manage the PKI certificates and associated levels of trust, and thus may report the available levels of trust to the productivity system 250 or otherwise allow selection of the available levels of trust for associating with a zone. As described, the levels of trust can include whether an NDA (or certain NDA or level of NDA) has been signed, whether a certain training course or level of training has been completed, whether a certain level of certification has been achieved, whether communication is allowed for personnel based on health insurance portability and accountability act (HIPAA) guidelines, whether the person is of at least a certain position (or of an appropriate position) within the corporation for the meeting, etc. In an aspect, the trust verification system 215 can manage identities of persons in the corporation, which can include corresponding biometric information that matches the identities, and PKI certificates for High Assurance for the identities that correspond to levels of trust (e.g., PKI certificates for having signed an NDA, for certain levels of certification, etc.).

At block 304, method 300 can include identifying one or more persons of multiple persons within a zone. In an aspect, person identifying component 220, e.g., in conjunction with computing device 200, processor 205, memory 210, trust verification system 215, etc., can identify one or more persons of multiple persons within the zone. For example, where the zone is a physical zone (e.g., in a building), person identifying component 220 can identify one or more persons in the zone using facial recognition or other biometric verification. Where the zone is a virtual zone, for example, person identifying component 220 can identify the one or more persons based on login credentials, or similarly based on biometric verification (e.g., via a camera on a person device), etc. In one example, person identifying component 220 can identify persons in the zone upon arrival, or can periodically identify persons in the zone, etc., to detect persons that have arrived or have left the zone. As such, for example, the persons identified in the zone may change over time.

At block 306, method 300 can include determining, based on identifying the one or more persons, whether the one or more persons are associated with a level of trust. In an aspect, trust level component 225, e.g., in conjunction with computing device 200, processor 205, memory 210, trust verification system 215, etc., can determine, based on identifying the one or more persons, whether the one or more persons are associated with the level of trust. For example, the level of trust can be indicated for the zone, and trust level component 225 can determine whether the one or more persons in the zone are of at least the level of trust associated with the zone.

In determining whether the one or more persons are associated with the level of trust at block 306, optionally at block 308, it can be verified whether an identification of the one or more persons is associated with a valid certificate associated with the level of trust. In an aspect, trust level component 225, e.g., in conjunction with computing device 200, processor 205, memory 210, trust verification system 215, etc., can verify whether the identification of the one or more persons is associated with the valid certificate associated with the level of trust. For example, the identification of the one or more persons can include an identification determined by the person identifying component 220, such as a profile in the trust verification system 215 and/or in an employee database of the corporation. In addition, for example, the identification can be associated with one or more levels of trust, which can include an association with one or more PKI certificates that correspond to a level of trust. In this example, trust level component 225 can verify whether identifications of the one or more persons are associated with the PKI certificate that corresponds to the level of trust associated with the zone, as described. For example, the trust verification system 215 can associate PKI certificates with the identification that represent certain levels of trust for the identification, such as whether the person has signed an NDA, has completed a level of certification, etc. In an example, an administrator can manually associate the identifications with the PKI certificates, or the association can be automated (e.g., the trust verification system 215 can provide the NDA for signature and when the person, e.g., digitally, signs an NDA, the trust verification system 215 can associate the identification with the appropriate digital certificate.

In addition, for example, the PKI certificates may have associated expiration times or may otherwise be invalidated. Thus, for example, verifying whether the identification is associated with a PKI certificate can also include ensuring the PKI certificate, if present, is valid, is not expired, has not been revoked, etc.

At block 310, method 300 can include setting an observable indicator to specify whether the multiple persons in the zone, including the one or more persons, are associated with the level of trust. In an aspect, indicating component 230, e.g., in conjunction with computing device 200, processor 205, memory 210, trust verification system 215, etc., can set the observable indicator to specify whether the multiple persons in the zone, including the one or more persons are associated with the level of trust. For example, the observable indicator can be a visual indicator in a conference room or an icon in a virtual conference on a productivity application, an audio indicator in the conference room or played in the virtual conference, a personal notification (e.g., as an email, text alert, pop-up etc.) delivered to one or more devices of one or more persons scheduled to be in the zone, such as to attend a meeting, and/or the like. In one example, indicating component 230 can set the observable indicator for all persons in the zone or to only certain persons (e.g., a presenter).

For example, indicating component 230 can set or modify (e.g., reset) the indicator to indicate whether all persons in the zone are associated with the level of trust for the zone, or whether at least one person in the zone is not associated with the level of trust, etc. In an example, indicating component 230 can determine the indicator to use and/or a configuration of the indicator (e.g., light color, audio alert tone, etc.) from a configuration for the zone (e.g., as received from a zone configuring component 240, productivity system 250, etc.). Moreover, in an example, indicating component 230 can be operable to indicate for multiple levels of trust (e.g., different indicators for different levels), as described herein. In addition, indicating component 230 can set the indicator based on determining that the indicator should be changed, which can be based on detecting at least one person that is not associated with the level of trust, based on detecting that all persons are associated with the level of trust, etc.

In an example, the status of the zone can change as people enter and exit the zone. Thus, in one example, indicating component 230 can indicate that there is at least one person in the zone that is not associated with the level of trust. This person may subsequently leave the zone. In one example, method 300 can be continually or periodically performed to update the status of the zone. In an example, after the untrusted person leaves, person identifying component 220 can identify the persons in the zone as not including the untrusted person, trust level component 225 can determine that the persons in the zone comply with the level of trust, and indicating component 230 can switch the indicator to indicate that the zone now includes only persons that are associated with the level of trust for the zone.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage de-vices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated other-wise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for verifying a level of trust in a zone having multiple persons, comprising:
identifying one or more persons of the multiple persons within the zone;
determining, based on identifying the one or more persons, whether the one or more persons are associated with a level of trust; and
setting an observable indicator to specify whether the multiple persons in the zone, including the one or more persons, are associated with the level of trust.

2. The computer-implemented method of claim 1, wherein the zone is a meeting room in a building.

3. The computer-implemented method of claim 2, wherein setting the observable indicator includes at least one of setting a light bar within the meeting room to a certain color, or sending an email, text message, or pup-up alert to one or more of the multiple persons that are in the meeting room or are scheduled to be in the meeting room.

4. The computer-implemented method of claim 1, wherein the zone is a virtual meeting.

5. The computer-implemented method of claim 4, wherein setting the observable indicator includes at least one of setting the observable indicator in a client application for the virtual meeting, or sending an email, text message, or pop-up alert to one or more of the multiple persons that are attending, via the client application, the virtual meeting or are scheduled to attend, via the client application, the virtual meeting.

6. The computer-implemented method of claim 1, wherein determining whether the one or more persons are associated with the level of trust includes verifying whether an identification of the one or more persons is associated with a valid certificate associated with the level of trust.

7. The computer-implemented method of claim 6, wherein the valid certificate corresponds to the one or more persons at least one of having signed a non-disclosure agreement, having completed a training course, having a certification, or having a position at a corporation.

8. The computer-implemented method of claim 1, wherein identifying the one or more persons includes performing facial recognition to identify the one or more persons.

9. The computer-implemented method of claim 1, further comprising receiving an indication of the level of trust to be associated with the zone for a period of time.

10. An apparatus for verifying a level of trust in a zone having multiple persons, comprising:
a memory; and
a processor communicatively coupled with the memory and configured to execute a trust verification system for:
identifying one or more persons of the multiple persons within the zone;
determining, based on identifying the one or more persons, whether the one or more persons are associated with a level of trust; and
setting an observable indicator to specify whether the multiple persons in the zone, including the one or more persons, are associated with the level of trust.

11. The apparatus of claim 10, wherein the zone is a meeting room in a building.

12. The apparatus of claim 11, wherein setting the observable indicator includes at least one of setting a light bar within the meeting room to a certain color, or sending an email, text message, or pup-up alert to one or more of the multiple persons that are in the meeting room or are scheduled to be in the meeting room.

13. The apparatus of claim 10, wherein the zone is a virtual meeting.

14. The apparatus of claim 13, wherein setting the observable indicator includes at least one of setting the observable indicator in a client application for the virtual meeting, or sending an email, text message, or pop-up alert to one or more of the multiple persons that are attending, via the client application, the virtual meeting or are scheduled to attend, via the client application, the virtual meeting.

15. The apparatus of claim 10, wherein determining whether the one or more persons are associated with the level of trust includes verifying whether an identification of the one or more persons is associated with a valid certificate associated with the level of trust.

16. The apparatus of claim 15, wherein the valid certificate corresponds to the one or more persons at least one of having signed a non-disclosure agreement, having completed a training course, having a certification, or having a position at a corporation.

17. The apparatus of claim 10, wherein identifying the one or more persons includes performing facial recognition to identify the one or more persons.

18. The apparatus of claim 10, wherein the processor is further configured to execute the trust verification system for receiving an indication of the level of trust to be associated with the zone for a period of time.

19. A computer-readable medium storing instructions, executable by a processor, for verifying a level of trust in a zone having multiple persons, the instructions comprising instructions for:
identifying one or more persons of the multiple persons within the zone;
determining, based on identifying the one or more persons, whether the one or more persons are associated with a level of trust; and
setting an observable indicator to specify whether the multiple persons in the zone, including the one or more persons, are associated with the level of trust.

20. The computer-readable medium of claim 19, wherein the zone is a meeting room in a building or a virtual meeting room.
